(19) United States
(12) Patent Application Publication
(10) Pub. No.: US 2003/0009407 A1
(43) Pub. Date: Jan. 9, 2003

(54) Method of measuring inflation for the consumer price index

(76) Inventor: Peter Twardowski, Toronto (CA)

Correspondence Address: ELIAS C. BORGES, BORGES BANASINSKI ROLLE LLP, 10 KINGSBRIDGE GARDEN CIRCLE, SUITE 704, MISSISSAUGA, ON, L5R 3K6, CA

(21) Appl. No.: 10/124,693

(22) Filed: Apr. 9, 2002

Related U.S. Application Data
(63) Continuation-in-part of application No. 09/856,566, filed on May 23, 2001.

(51) Int. Cl. G06F 17/60

(52) U.S. Cl. 705/36

(57) ABSTRACT

A method of measuring a more accurate rate of inflation is provided. The method consists of first creating a necessities index by selecting a plurality of household expenditures whose price changes are to be measured over the time period. The plurality of household expenditures must include only those expenditures which are subject to time constraints. The necessity index will be restricted to household expenditures for food, transportation, shelter, clothing, footwear and hygiene products. The rate of inflation can then be derived by measuring the rate of inflation of the necessities index. The method can be rendered more accurate by excluding from the necessities index any expenditure which is of a luxurious nature. The method can be further refined by including into the necessities index household expenditures which are made by a great majority (approximately 95%) of households.

### CROSS REFERENCE TO RELATED APPLICATIONS

This application is a continuation-in-part of application Ser. No. 09/856,566 entitled Method of Calculating a Consumer Price Index, the entirety of which is incorporated herein by reference.

### FIELD OF THE INVENTION

The present invention relates to methods of measuring economic indicies such as inflation.

### BACKGROUND OF THE INVENTION

The periodic measurement of the rate of inflation is important for setting monetary and economic policies. Traditionally, the rate of inflation has been measuring the period changes in the price of certain products and services. The changes in these goods and services is referred to as the consumer price index. The fundamental problem with the Consumer Price Index (CPI) is its size (or the size of the basket); i.e. the CPI attempts to measure the change in the price of too many goods and services. If, for example, there is an inflation rate of 5% for food and a deflation rate of 5% for recreation, an equal treatment (weights) for both, will give the composite inflation rate (an inflation rate expressed in one number) of 0% (no inflation), because 50% weights for food (at 5% inflation) and 50% for recreation (at 5% deflation), are added together in the following manner: (0.5*1.05)+(0.5*0.95)=0.525+0.475=1.00. (Since 1.05 stands for 5% inflation and 0.95 for 5% deflation, then the final number 1.00 means 0% inflation.) However, if recreation conceptually does not fit into the basket and is to be excluded from it, this changes the inflation rate from 0% to 5% because only food is now considered. This also means that the previous 0% composite inflation was understated by 5%.

Another main problem with the CPI is the application of weights. Weights are needed to construct a basket and a composite inflation rate. The current CPI weights are derived from household expenditures. This invention introduces new weights and a method of their application. The following example shows an effect of the application of different weights on a composite inflation rate, and by the same, their importance. If 30% weights are applied to food and 70% to transportation, at 10% inflation for food and 0% inflation for transportation, the composite inflation is 3%, since (0.3*1.1)+(0.7*1.0)=0.33+0.7=1.03=3%. But if 70% weights are applied to food and 30% to transportation, at the same 10% inflation for food and 0% for transportation, the composite inflation changes to 7%, because (0.7*1.1)+(0.3*1.0)=0.77+0.3=1.07=7%.

Since Consumer Price Index is known as the Cost of Living Index, then it should account for the full cost of living. But in reality it does not. It is concerned with the cost incurred by consumers at the retail level, ignoring the cost being subsidized by governments. Therefore, CPI will not show a higher cost of living if this higher cost goes to subsidies, which are higher now than before.

### SUMMARY OF THE INVENTION

The present invention overcomes the disadvantages of the prior art by providing a method of measuring a composite rate of inflation for only those products which are truly necessary. The method consists of first creating a necessities index by selecting a plurality of household expenditures whose price changes are to be measured over the time period. The plurality of household expenditures must include only those expenditures which are subject to time constraints. The necessity index will be restricted to household expenditures for food, transportation, shelter, clothing, footwear and hygiene products. The rate of inflation can then be derived by measuring the rate of inflation of the necessities index. The method can be rendered more accurate by excluding from the necessities index any expenditure which is of a luxurious nature. The method can be further refined by including into the necessities index household expenditures which are made by a great majority (approximately 95%) of households.

### DETAILED DESCRIPTION OF THE INVENTION

Basis for Measuring Inflation

The real sources of inflation have never been understood in economics. But now, this invention provides an explanation for it and builds a method of measuring inflation based on it. There is a single and simple explanation for the sources of inflation. These sources are time constraints. Time constraints prevent consumers from foregoing numerous expenditures, postponing them, or waiting for various prices to come down. Without time constraints, consumers would be able to fight inflation. They could comfortably walk away from higher prices at any time because they wouldn't have to buy today, tomorrow, next week, next month or next year. Besides, they wouldn't ever have to work and could live their entire lives without consuming anything. In such environment, there would be no problem of inflation and a need for measuring it. But that is not a reality and that is why the new method of measuring CPI inflation comes from the sources of inflation—time constraints.

The following is a classification and a brief explanation of three different categories of expenditures with respect to time constraints and their absence.

Necessities—Needs

The term “necessities of life” simply means that people cannot live without them. That is why people must work in order to earn money to buy them, and consume them at specific points in time. These specific points in time are time constraints. All necessities are characterized by the possession of time constraints because without time constraints, necessities would not be necessary. The nature of time constraints can be explained by a reference to the demand for food. It can be symbolized by the expression “three meals a day (every day).” This expression reveals two variables with regard to the demand for food: the quantity (three meals) and the time (a day). The quantity demanded depends on time because the demand for food derives from the physiological needs of people which means that time tells people when to eat. Therefore, people cannot and do not wait for food prices (prices relate to the consumption of food not to the demand) to come down because a consumption of three meals is constrained to a single day. Without that constraint, food would not have to be consumed and would not be a necessity. (Of course, the above expression only represents the idea of the demand for food and does not contradict a possibility of consuming two larger, or four smaller meals daily.)

Another characteristic for necessities is a lack of substitutions. Food has no substitutes and must be consumed at specific points in time (That is why it is a necessity). However, selective food goods are not necessities because they have substitutes and there are no specific time constraints on their demand and consumption.

All necessities can be classified as either deep core necessities or shallow core necessities. The difference between them is simple; people cannot live without deep core necessities (in terms of physiological needs) but they can without shallow core necessities. To the deep core necessities belong: food, shelter, clothing and footwear, and to the shallow core: transportation, hygiene products and some others.

Non Necessities—Wants

Unlike necessities, no time constraints can be attributed to non necessities which are psychological wants of people. These wants can change at any time which means that they can be substituted one for another. Recreation is a non necessity because people can live without it, since they can substitute saving money for spending on recreation, and they can fight inflation by waiting for recreation prices to come down. Therefore, non necessities are going to be largely excluded from the basket, and will not be a part of the new method of measuring inflation.

Semi Necessities

Semi necessities posses some types of time constraints and belong between necessities and non necessities. Hence, semi necessities do not have to be purchased because people can live without them, however, all households have them. A phone and a watch are good examples of semi necessities; people could live without them (in terms of physiological needs), but they don't. Also, when the time to buy a phone and a watch comes, people do not wait for their prices to come down and thus are practically unable to fight their inflation. This is the reason why semi necessities will be a part of the new method of measuring inflation. With respect to time constraints however, semi necessities are unequal because some of them can be placed closer to necessities, while others, closer to non necessities. This means that if a low income consumer would like to purchase two semi necessities but can only afford one, the one he chooses is more necessary than the other.

There are two types of semi necessities. The first type are shallow core necessities as mentioned earlier. Unlike deep core necessities which had always been necessities, the shallow core necessities became (and indeed are still becoming) necessities at different points in time. Their continuously increasing length of existence brings them closer to deep core necessities because the longer they are around, the harder it becomes to live without them. A phone and a watch are shallow core necessities.

The second type of semi necessities include goods which can be viewed as a subset of a necessity. For example, Food is a necessity since people are constrained to consume food within a time constraint; however, specific food products such as eggs, milk and bread are merely a semi necessity because, while they are all food products, consumers are not constrained to eat those specific food products—they may choose to consume other food products instead. This means that people can live without bread, eggs and milk (since they can consume something else instead), but they cannot without food. However, unlike lobsters, oysters and caviar which are expensive and not commonly consumed on a daily basis, food products such as bread, eggs and milk are often part of a consumers daily meals. In western culture, consumers are accustomed to consuming bread, eggs and milk on a nearly daily basis, therefore, it is unlikely for consumers to walk away from moderately higher prices of bread, eggs and milk, and buy expensive seafood instead. That is why bread, eggs and milk may be considered as semi necessities.

### THE NEW METHOD

Since the science of economics does not understand time constraints as sources of inflation, the existing CPI basket contains various expenditures to which time constraints cannot be attributed. These non necessity expenditures have to be first identified and then excluded from it in order for the composite inflation rate not to be overstated or understated (as in the first example). That is the first step of the new method. Subsequently the basket becomes smaller and is now named the necessity index because it only contains expenditures for deep and shallow core necessities.

Step #1

Selection of Expenditures for the Necessity Index

There is no ideal way of deciding which expenditures do and do not belong into the necessity index because certain expenditures are shallow core necessities for some households but non necessities for others, and because drawing the line between semi and non necessities in the food component for example cannot be performed satisfactorily since these goods all together may be seen as either semi or non necessities. However, it must be stressed that the objective of this invention is not an ideal selection of goods/commodities into the necessity index. It is about a brief identification and inclusion (into the index) of expenditures for these goods/commodities. (The term expenditure will be explained later.) Only those expenditures to which time constraints can be attributed are included because fighting inflation for any of them is not feasible by consumers. That is the main advantage of the present invention over the existing CPI. Also, this invention provides a solution to the uncertainty of inclusion of some expenditures as part of the necessity index by a way of reducing their significance through a new and different application of weights (as shall be discussed later). Another solution to an uncertainty of inclusion is a reference to statistical data. If 95% of households make the same expenditures at specific and repetitious points in time (this applies to deep and shallow core necessities), then these expenditures have characteristics of time constraints and conceptually belong to the necessity index. The figure of 95% is only referential and it really means all households since very low income households without a phone would all get one if winning a lottery. This statistical information can be obtained by a modification to surveys of household expenditures.

The following is a brief description of the necessity index based on the modified CPI's major components. This index has been created only as a guideline for selecting expenditures. It is not an absolute reference for making such selection. Also, this step is performed in conjunction with the next one. The next step is about the reduction of costs. Therefore, in this step there are exclusions of additional and unnecessary cost/expenditures.

Food

By saying earlier that non necessities are going to be largely excluded from the basket, it meant that those non necessities which belong to major components of the necessity index cannot be. Food component has these non necessities. (If bread, eggs and milk may be considered as semi necessities because they represent a basic consumption of food, then expensive meat cuts and expensive cheeses may be considered as non necessities because they represent an upscale consumption of food, and are being purchased accordingly to people's budget and in consideration for their pricing.) They cannot be excluded because measuring inflation for food can only be realized by measuring price movements of these non necessities together with price movements of semi necessities. However, the significance of non necessities will be diminished and semi necessities increased by a different application of weights. Nevertheless, it is reasonable to exclude very expensive seafood such as lobsters, oysters and caviar since these goods are scarce. Anything scarce at normal economic conditions is simply luxurious and unnecessary. Also, the consumption of food in cafes and restaurants is excluded from the necessity index because of the additional hospitality costs of eating out. People are able to fight inflation for these additional costs by not going to restaurants and, by the same token, not consuming seafood. Therefore, only the cost of food is considered in the necessity index because it is necessary and has to be incurred.

Shelter

Shelter as a necessity means a place to sleep. It should not be misunderstood with a home, a backyard or real estate ownership. Also, it should not possess the characteristics of a good location or a good neighbourhood. This eliminates land from a building leaving basic household operations plus water, gas and hydro as necessities. Therefore, measuring inflation for shelters means measuring changes in costs of new residential developments with disregard for what the consumers pay in the form of mortgage payments and total price for a home (since they always pay for the land). But buying a home is not buying just a shelter. New homes may have many non necessity amenities such as swimming pools which are popular in condominiums. These features do not belong to the necessity index. Hence, a modified perception of the home is needed for the shelter component. All seasonal and recreational properties do not belong under the concept of shelter, but residential apartment buildings, detached and semidetached houses do.

Clothing and Footwear

Clothing and footwear may have a non necessity features to it. For example, a simple shoe costing a few dollars may be a necessity, but a very stylish shoe made by a famous design house may be viewed as a luxury item. Hence, non necessity aspect of this component comes from fashion. However, it might not be feasible to completely eliminate fashion from the necessity aspect of clothing and footwear (concerned with climate and weather), because most new clothes and shoes are fashionable. If the clothing is worn on a daily basis then they can be included in the necessity index. However, if the clothing is intended to be worn only on special occasions it should not be included in the necessity index. Also, professional attire which is necessary in today's workplace can (to a certain extent) be considered as a necessity. But all sport's and recreational clothing and footwear as well as all jewellery and other decorative items are excluded from the index.

Transportation

With respect to specific time constraints, the need for transportation comes from commuting to work on a daily basis (because “work is a necessity”), and from transportation relating to shopping. Therefore, airline transportation does not belong to the necessity index. But even expenditures for cars cannot be fully included in the index for the following reason. Cars may be used for holiday driving or for driving for the purpose of recreation. These additional expenditures/costs are unnecessary and do not need to be incurred. Also, a further reduction in costs can be made by a decrease in distances between homes and workplaces (by living closer to work or working closer to home). This reveals that the necessary costs which must be incurred by consumers and which symbolize the need for transportation, stand below the total and actual expenditures for cars. From the necessity perspective, only these necessary costs should be included in the index. That is why only a partial inclusion of expenditures for cars is appropriate for transportation. Furthermore, if a bicycle can be a substitute for a car, and more and more people start to ride bikes, then low expenditures for bicycles are going to drive down the necessity costs further. This indicates that the necessity aspect of transportation is vague, allowing for a wide range of cost alternatives. As shall be discussed later, the application of weights can be used to correct for the non-necessary use of cars.

Hygiene Products

Hygiene products are not cosmetics. Cosmetics are being bought in order to look or smell good and no time constraints can be attributed to them. Hygiene products are part of daily hygiene and therefore every household buys them. Products such as soap, shampoo and toothpaste are necessities by themselves since one cannot be substituted for another. Expenditures for hygiene products are low.

Household Operation and Furnishings

Most furnishings and basic household goods as well as some appliances are necessities. The necessity aspect of this component however is low because furnishings and appliances can last more or less thirty years, and from the yearly perspective, their cost is not very significant.

Other Shallow Core Necessities

These are all those which 95% of households have them. In western culture they are: phone, watch, TV, radio, etc.

Non Necessity Components

There are several exclusions of fill components from the necessity index. Health care is one of them. Some aspects of health care however could be included in the index as shallow core necessities. The main reason for excluding health care is that while nobody can live without food, there are some lucky ones who will never get seriously sick during their lifetime, and who will not need health care. That is because there are no specific points in time (time constraints) which could indicate when people are going to get sick. Besides, the necessity index should include only those expenditures which are pertinent to everyone, because they are necessary to everyone.

Another exclusion is made for education. Education is very psychological and intellectual but not a physiological aspect of life. Reading, recreation, tobacco and alcohol are all excluded as well.

Step #2

Application of Weights

This step contains three subsequent steps or parts: A, B and C. They are independent and can be performed in any order.

### Part A

Weights can be defined as relative significance of necessities, semi necessities and non necessities or, significance of their price movements. They stem from multiplying quantities of the product purchased, by prices of that product, to give an expenditure for that product. Thus: P*Q=E (a definition of expenditure). For example, if an individual buys 50 loaves of bread yearly at $2 each, then a yearly expenditure for bread is $100. Expenditures for all other food products are summed with the expenditure for bread. If the total expenditure for food is $2,000.00 yearly, then 5% weights are applied to the expenditure for bread (in the food component), because the relative significance of bread is expressed in percentage numbers. The same process applies to major components. The existing CPI weights are derived from household expenditures and they change with changes in these expenditures. Hence, this approach can be named the expenditure factor in the application of weights. But as far as major components of the necessity index are concerned, the new method abandons this approach and introduces a new type of weights. Their application consists of three tasks:

1. Selection of expenditures for the necessity index,

2. Inclusion of government subsidies,

3. Estimation of costs.

The first task was performed in the previous step (the selection of what will be included in the necessities index). An inclusion of government subsidies is going to be briefly mentioned in the next step, and it is simply a consideration for the full costs of necessities. The novelty of the new type of weights comes from estimation of costs. These weights are about focussing on the costs of necessities and household expenditures serve only as a reference for them. This implies that the costs of necessities do not match with household expenditures. That is because the term cost has liability characteristics (the necessary cost which has to be incurred), but household expenditures don't, and do not symbolize the necessity aspect of the cost of living. The difference between these two can be understood more clearly by an explanation of what the necessity aspect of transportation is about. It is about overcoming a distance at specific time constraints. Without a distance, people would still have to work and shop (at specific time constraints) but close to their homes and without a need for vehicles. Therefore, the cost of overcoming a distance at specific time constraints but not the total expenditures for cars which stand way above that cost, is what the new method is concerned with. Furthermore, some people do not mind incurring higher costs of transportation by driving larger distances once they find their dream homes. These dream homes are not shelters and larger distances are unnecessary. This calls for finding a distance which symbolizes the need for transportation. But such distance cannot be found. It can only be estimated. Hence, an estimation of costs means an estimation of a distance first and then an application of costs for overcoming that distance. (The costs attributed to a car are the costs of gasoline, insurance, maintenance and a yearly cost of the car, all based on that distance. The costs of other vehicles as well as the cost of public transportation are also considered.) Thus, household expenditures are subordinate to distance and serve only as a reference for the costs of overcoming a distance. Since additional costs are unnecessary, the new method is concerned with the minimum, necessary but reasonable costs. This approach reduces the problem of applying a wide range of costs to transportation. Transportation costs however are reasonable because they cannot be reduced too low, to the costs of bicycles (which are the lowest) if people don't ride bikes. Nevertheless, an application of necessary but reasonable costs to transportation, diminishes the difference between the costs of cars and bicycles, and takes into consideration a possibility of more people riding bikes. The following example shows a problem of applying high and then low weights to transportation, based on total expenditures for transportation. At high expenditures for transportation, 70% weights are applied to transportation and only 30% to food. But if transportation expenditures are low, 70% weights are applied to food and 30% to transportation. At 3% inflation for food and no inflation for transportation, there are two composite inflation rates. The first one at 70% weights for transportation is 0.9%, because (0.7*1.0)+(0.3*1.03)=0.7+0.309=1.009=0.9%, and the second one at 30% weights for transportation is 2.1%, because (0.3* 1.0)+(0.7*1.03)=0.3+0.721=1.021=2.1%. The difference between these two composite rates is 1.2%. Now, if people are saving their money for the future, and if 3% inflation for food and 0% for transportation continues for years, and if not cars which currently give 70% weights to transportation (only in this particular example), but very different vehicles (inexpensive, similar to bicycles) are going to be produced in the future, then expenditures for these vehicles may give 30% weights to transportation, and people will lose money on their savings, because the existing method is not concerned with the application of weights in the future. That is why the new method streamlines the costs to the minimum, necessary but reasonable ones in order to avoid high fluctuations of future costs. It does not eliminate, however, significantly reduces the problem of cost fluctuations.

An application of minimum, necessary but reasonable costs in the new method is named the cost factor weights. Because these weights are not based on household expenditures, they do not change with changes in family composition (number of children), which otherwise would affect the food component because of different expenditures for food, and cause the same type of problem as illustrated above. These weights are applied to a single individual and on a yearly basis.

### Part B

An application of weights based solely on the cost factor is insufficient. On one hand, it is correct to apply high weights to high cost because an inflation of something cheap is not as significant as the same percentage inflation of something expensive, since an inflation of something expensive causes higher losses in buying power than an inflation of something cheap. (Minimum, necessary but reasonable costs are not the same. They differ.) But on the other hand, it is incorrect to do so because if something expensive becomes even more expensive, then people may walk away from buying it and thus, its high significance all of the sudden changes to zero/no significance. This is the reason why besides cost factor weights, the new method, introduces another type of weights. These weights come from the concept of chronological order of expenditures which means that certain expenditures must be made before others. The following (simple) example gives an explanation for it. Consumers should not buy appliances first and then find out if they have the money to pay for the hydro. Also, they should not buy appliances and pay for the hydro if they are homeless. This means that shelter must be the highest in the order/hierarchy of expenditures, then the hydro and after the hydro, the appliances. To say it otherwise, whatever is at the bottom of the hierarchy of expenditures may not be purchased if it becomes relatively expensive. Such relativity stands for higher costs of those expenditures which are higher in the hierarchy, as well as loss of jobs. Therefore, if people forego or postpone certain expenditures and producers are unaware of it and produce as much as before, eventually related prices will move downward, because producers will try to sell their products. However, this type of price movements is not pure since people substituted non consumption (if they don't have money) or savings (if they do) for consumption of these products. But the idea of measuring inflation is to measure pure price movements. Substitutions on the other hand are an impediment for doing so because they cause a substitution bias. Therefore, the concept of chronological order of expenditures gives a high hierarchy (high weights) to expenditures with low or no chances of substitutions, and a low hierarchy to those where substitutions are very probable. This way, the bias is reduced.

The above concept only describes the idea of reducing the bias. It is not a base for the application of weights. There are two reasons for it. It would be very difficult for statisticians to find out from surveys about the order of expenditures. (The same survey done twice could bring different results). The second reason lies in the problem of applying abstract numbers derived out of the concept into the index. These numbers should be practical and realistic. Therefore, the second type of weights comes from the concept of chronological order of expenditures, but is based on the length of existence. The higher the length of existence, the higher the hierarchy (weights). But the length of existence is not an obvious and definable length of time. Hence, it has to be estimated. However, advantages of using the length of existence in the application of weights are not immediate, but will become apparent the farther into the future. That is because in the future, new necessities will be getting the smallest “weight time unit” (which may be the period of time between surveys), and the length of existence of existing necessities will become greater and thus, more distinct. An application of weights based on the length of existence gives a practical and realistic application of numbers into the index. As mentioned earlier in the description of shallow core necessities, their continuously increasing length of existence makes it harder to live without them. This can be translated into the language of inflation in the following manner: the longer the existing necessities are around, the harder it becomes not to buy them at a higher price.

An application of weights based on the length of existence is named the time factor weights. The cost and the time factor are both significant and the new method gives them an equal share of weights—50% each. However, even with a different distribution of weights, the new method remains solid. Furthermore, a diversification of the time and cost summation can be made to better address certain aspects of significance of necessities (as well as semi and non necessities). This however is beyond the scope of this invention.

The following example is an illustration of what have been said so far. It is only a very brief depiction of the concept.

If all necessities of the necessity index can be classified as either:

a) deep core necessities, or

b) shallow core necessities, or

c) new necessities,

then if their costs are equal, a distribution of cost factor weights is equal as well.

| Category | Cost factor (%) |
|---|---|
| Deep | 33.33 |
| Shallow | 33.33 |
| New | 33.33 |

But if all households have the Internet, then it may be considered as a necessity and it should be included in the index. However, the Internet costs are high (they are purposely chosen high to better illustrate the concept), and could substantially take away weights from other necessities. The distribution of weights is as follow:

| Category | Cost factor (%) |
|---|---|
| Deep | 25 |
| Shallow | 25 |
| New | 25 |
| Internet | 25 |

Therefore, there is an uncertainty of inclusion of the Internet into the index. It is included after all. Sometimes later (for numerous reasons), several households are no longer spending on the Internet. In other words, they are making substitutions. As a result of it, there is no inflation for the Internet. But in the meantime, deep core, shallow core and new necessities experience 4% inflation. This gives the following result: (0.75*1.04)+(0.25*1.0)=0.78+0.25=1.03=3% inflation. Consequently, the question of the inclusion of the Internet into the necessity index comes back. Without the Internet, the composite inflation rate would stand at 4%. However, according to the chronological order of expenditures, the deep core necessities are the highest in hierarchy, then shallow core necessities, then new necessities, and the Internet is at the bottom. Also, the length of existence of the Internet is marginal and a distribution of weights based on the length of existence (and at 50% for the cost factor and 50% for the time factor) could give the following and total numbers:

| Category | Cost factor (%) | Time factor (%) | Both factors (%) |
|---|---|---|---|
| Deep | 12.5 | 30 | 42.5 |
| Shallow | 12.5 | 15 | 27.5 |
| New | 12.5 | 4.5 | 17 |
| Internet | 12.5 | 0.5 | 13 |

The total weights are 13% for the Internet and 87% for the rest of the index. At 4% inflation for the rest of the index and 0% inflation for the Internet, the composite inflation rate is: (0.87* 1.04)+(0.13*1.0)=0.9048+0.13=1.0348=3.48%. Thus, it is higher with time factor weights. Also, if pure price movements (without households making substitutions) for the Internet could give 4% inflation, then at actual 0% inflation for the Internet, the substitution bias is 4% (for the Internet). In the environment of the composite inflation rate, and without time factor weights, the bias stands at 1% (a difference between 4 and 3%). But through an application of time factor weights, the bias is reduced almost by a half percentage point, exactly 0.48%. Therefore, an application of time factor weights diminishes the impact of inclusion of the Internet into the necessity index.

### Part C

An application of cost factor weights in part A, and time factor weights in part B, pertained to major components of the necessity index. But as far as semi and non necessities of these components are concerned, this invention offers no changes to an application of weights derived from household expenditures, and therefore, does not use estimation of costs as an applying method.

The concept of applying time factor weights to semi and non necessities is virtually the same as in part B. For semi and non necessities however, the length of existence means the length of time of no substitutions. The idea of applying time factor weights is to increase significance of semi necessities since they are characterized by a low chance of substitutions. Therefore, semi necessities are almost necessities. Furthermore, since the new method of measuring inflation concerns the necessity index, price movements of semi necessities represent that index. Non necessities on the other hand are treated in the same way as was the Internet in the example of part B. The significance of their high cost is reduced by time factor weights. But if in time they are going to experience no substitutions, time factor weights will gradually increase that significance. However, non necessities naturally experience substitutions because they are more expensive than semi necessities.

Step #3

Inclusion of Government Subsidies

The total cost of necessities would not be complete without government subsidies because these costs stand below minimum, necessary but reasonable ones. In other words, the omission of subsidies in measuring inflation makes the significance of the cost factor understated. This way the real cost of living as well as its inflation cannot be truly revealed. Also, future changes in subsidies will alter the significance of the cost factor thus altering the composite inflation rate. These are the reasons why government subsidies are included in the necessity index.

(It is possible to run the necessity index without government subsidies. This can be accomplished through government policies which are very consistent and which do not interfere with any aspect of measuring inflation for the cost of living. Nevertheless, in such case, the new method still remains solid.)

Step #4

Admittance of a New Necessity into the Index

This invention gives two criteria for the admittance of a new necessity into the index:

1. Expenditures for the necessity in question by all households,

2. Lower relative cost of existing necessities.

As mentioned earlier, if all households (or 95%) make the same expenditures at specific and repetitious points in time, then these expenditures have characteristics of time constraints and conceptually belong to the necessity index. This criterion serves at the initial selection of expenditures for the necessity index. But it is also used as a first criterion for the future admittance of a new necessity into the index. The second criterion (which applies only for the future admittance) is explained in this step. (An application of time factor weights is a way of dealing with a new necessity once admitted into the index, but it is not a criterion for such admittance.)

Relative cost is a cost ratio. Hence, the cost of necessities and non necessities can be measured as a ratio of the necessity index to the existing CPI. Since the costs of the necessity index are minimal, necessary but reasonable, together they denote the cost of living. All additional, non necessary costs represent the standard of living. Therefore, this ratio may be called the cost-standard of living ratio. The reason for the creation of this ratio is to monitor changes in the relative costs of existing necessities from the perspective of changes in the standard of living. A growth in the standard of living occurs at:

a) higher quantitative expenditures for non necessities, or in the relative sense,

b) lower costs (deflation) for necessities,

c) lower inflation for the cost of living than for the standard of living.

In such cases, a new necessity might be admitted into the index because higher standard of living gives lower relative cost for the existing necessities. However, as far as higher quantitative expenditures for non necessities are concerned, they must derive from higher average household earnings because higher earnings reflect higher standard of living. If on the contrary these higher expenditures are a result of changes in family composition, savings or financing, then they do not denote a higher standard of living. Therefore, average household earnings can be used together with the cost of necessities as the earnings-cost of living ratio, another indicator for monitoring changes in the cost and standard of living, and for allowing new necessities into the index.

The idea of admitting a new necessity into the index at a higher standard of living (and a lower relative cost of existing necessities) is to assure a better endurance of that necessity in the index. An admittance of any necessity at a decline in the standard of living is inappropriate because such necessity becomes relatively more expensive. This could cause first an admission and then exclusion from the index if some households discontinue to buy that necessity. Therefore, since references to cost-standard of living, and earnings-cost of living ratios can avoid that.

Step #5

Reindexing of Weights

Reindexing of weights means an application of new cost and time ratios. As far as the cost factor weights are concerned, it is performed at the admittance of a new necessity into the index (or an exclusion from the index) and, but not necessarily, as a result of new data coming from expenditure surveys (or in other words, changes in expenditures). “Not necessarily” stands for a difference between the new and existing method. That is because in the existing method, weights are derived from household expenditures and they change with changes in these expenditures. In the new method, household expenditures serve only as a reference for cost factor weights. In this step, part A is about reindexing the cost factor, and part 1, the time factor weights.

### Part A

It has not been explained yet, how household expenditures serve as a reference for cost factor weights. Otherwise, how to link estimation of costs with household expenditures. This invention however goes only as far as the reduction of costs to the minimum, necessary but reasonable ones. It does not provide estimation techniques. That is because its important aspect is not estimation, but reduction of costs, since such reduction (which occurs at the selection of expenditures for the necessity index) is prior to estimation, and just by itself it is an improvement over the existing method. Consequently, this takes to reindexing of weights. If the initial estimation of costs is not an important aspect of this invention, then neither is an application of new (future) costs because they have to be estimated as well. This part briefly explains the rationale behind it. By the same, it explains why household expenditures can only serve as a reference for cost factor weights and why there cannot be a direct link between these two.

Since P*Q=E (as defined earlier), then changes in household expenditures can occur as a result of changes in quantities purchased or changes in prices (inflation, deflation). In the existing method, these changes cause reindexing of weights. But that is not necessarily the case in the new method. “Why not” can be explained by an example of a higher expenditure for a car. Here, higher quantitative expenditure means technological improvement to the car, since a more expensive car has more of everything. Applying higher weights to a car because of higher quantitative expenditures or inflation, increases its relative significance together with the significance of transportation, but decreases such significance for all other components. However, the more expensive the car, the less affordable it is. Hence, since transportation but not the car is a necessity, an expensive car might someday be replaced by other affordable vehicles affecting the composite inflation rate as shown in the earlier example. This indicates that applying higher weights because of higher (than before) expenditures could be incorrect if in the long run, these weights would have to come down. Therefore, an initial application of minimum, necessary but reasonable costs in the new method is performed from the long term perspective. That is precisely why neither the actual nor the future household expenditures serve as the foundation (but are only a reference) for cost factor weights.

### Part B

Reindexing of time factor weights for semi and non necessities is also performed as a result of changes in expenditures (new data coming from expenditure surveys). But even if there are no such changes (which is very unlikely to occur), the new method still calls for a regular update of time ratios. That is because time continuously changes the length of existence of semi and non necessities, thus changing their ratios. The regular update of time ratios however, does not apply to major components of the necessity index. If there is no new necessity coming into the index, such an update would overall continuously increase the relative significance of shallow core necessities, decreasing it for deep core necessities. On one hand, it is correct to do that because time brings all necessities closer together since the longer they are around, the harder it becomes to live without any of them and thus, they all become more equal in time. But on the other hand, the time factor weights derive from the concept of chronological order of expenditures and at the decline in the standard of living, new necessities (those at the bottom of the hierarchy of expenditures) would be the first ones to be excluded from the index. This means that time has not increased their relative significance. Therefore, reindexing of time factor weights for major components happens at the admittance of a new necessity into the index (or an exclusion from the index), because such admittance (exclusion) brings changes to the chronological order of expenditures expressed by the new time ratios. Hence, the length of existence of any particular necessity is bounded by the point in time of the admittance of a new necessity into the index, and it extends no further.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

What is claimed is:

1. A method of measuring a composite inflation rate comprising the steps of creating an index of necessities by selecting a plurality of household expenditures, the plurality of household expenditures restricted to those expenditures for food, transportation, shelter, clothing, footwear and hygiene products and then measuring inflation for the index of necessities.

2. The method of claim 1 wherein the plurality of household expenditures also includes any expenditure which is made by at least approximately 95% of households.

3. The method of claim 1 wherein household expenditures of a luxurious nature are excluded from the index of necessities.

4. A method of measuring a composite inflation rate comprising the steps of creating an index of necessities by selecting a plurality of household expenditures, said plurality of household expenditures restricted to only those expenditures which are subject to time constraints, and then measuring inflation for the index of necessities.

5. The method of claim 4 wherein the plurality of expenditures are restricted to only those expenditures for food, transportation, shelter, clothing, footwear and hygiene products.

6. The method of claim 4 wherein luxury expenditures are excluded from the index of necessities.

7. The method of claim 4 wherein the index of necessities also includes any expenditure which is made by at least approximately 95% of households.
